(19) United States
(12) Patent Application Publication
(10) Pub. No.: US 2016/0270988 A1
(43) Pub. Date: Sep. 22, 2016

(54) MODULARIZED MOBILITY DEVICE

(71) Applicant: CHALLENGING SOLUTIONS, INC., San Francisco, CA (US)

(72) Inventors: Rafael Ernesto Diaz-Flores, San Francisco, CA (US); Wesley Siebenthal, Orcutt, CA (US)

(21) Appl. No.: 15/074,946

(22) Filed: Mar. 18, 2016

Related U.S. Application Data
(60) Provisional application No. 62/134,889, filed on Mar. 18, 2015.

(51) Int. Cl. A61G 5/04; A61G 5/14; A61H 3/04

(52) U.S. Cl. CPC A61G 5/04; A61H 3/04; A61G 5/14; A61H 2003/043

(57) ABSTRACT

Disclosed are mobility devices configured for people with spinal cord injuries and other mobility disabilities. The provided mobility assistance combines manual and power modes with the benefits of standing and sitting. Additionally, the device is configurable for accessibility of use

### BACKGROUND

This disclosure relates to a modularized mobility device, which facilitates positioning a user in a stand-up supported position and a seated position.

Over 250,000 Americans have spinal cord injuries and there are approximately 11,000 new injuries per year. Persons with spinal cord injuries faces many challenges that could be reduced with appropriate equipment and resources. For example, passive standing is widely used clinically in both acute and chronic spinal cord injury (SCI) care. At a minimum, passive standing provides the patient with psychological benefits, but it may also provide physiological benefits in preventing soft tissue contractures and bone loss. Additionally, patients with spinal cord injuries require exercise. Currently available devices do not address the many and varied needs, including the abovementioned, of persons with spinal cord injury or enhance independence,

### SUMMARY

Disclosed is a mobility device for people with paraplegia and other mobility disabilities, included but not limited to, paralysis due to stroke, cerebral palsy, traumatic brain injury, degenerative disease and birth defects. The device provides mobility assistance that combines in one device the benefits of manual and power wheelchairs with the benefits of standing wheelchairs and rehabilitation devices. The mobility device has three wheels. Additional device functionality includes:

Modularity, Components of the device (seat, handles, steering, supporting wheels are configurable to be independent and fungible modules. This use of fungible modules increases adjustability of the device for a specific patient by allowing a selected module to accommodate the different body types, weights and user's needs. The modularity also facilitates the repair of the device by allowing for just the replacement of the required module and/or the repair of each module individually, as needed. Additionally, upgrades can be achieved by swapping out modules.

The device is configurable to be a self-propelled mobility device using three independently controlled brushless DC motors, which control a central back wheel and two frontal Mecanum wheels with onboard motion controllers for all DC motors. See, U.S. Pat. No. 3,876,255 A issued Apr. 8, 1975 to Hon for Wheels for a Course Stable Self propelling Vehicle Movable in Any Desired Direction on the Ground or Some Other Base; U.S. Pat. No. 8,011,735 B1 issued Sep. 6, 2011 to Scogna et al. for Wheel for Omni-Directional Vehicle. The front Mecanum wheels provide stability and allow the wheels to ride in any direction (forward, backward and sideways) allowing users to achieve a short turn radius. Other multidirectional wheels or systems may be used instead of Mecanum wheels. The brushless DC motors can be powered, for example, by one or more onboard Batteries, such as a lithium ion battery, or any other comparable power source. An onboard microcontroller is configurable to control and position of each motor independently to enable, traction using only the front wheels, traction using only the rear wheel, braking or stopping of one front wheel to facilitate the device to turn in one particular direction, breaking of both front wheels or breaking of the rear wheel which will allow a complete stoppage of the device.

The device is also device configurable to be hybrid powered by using a combination of power producers such as manual power and electric power. Additionally, energy generated may be stored in an energy storage medium, such as a battery and solar powered battery. For manual drive operation, the device is configurable to have, for example, two handle bars that connect via bearing flanges to a front-centered sub-frame element in which a sprocket holds a chain that connects to the main center wheel, like in a bicycle, and allows for manual movement that propels the device in a manual mode with a push-pull motion of the handle bars. The chain and wheel system has a linear to rotary transmission system that reduces the effort to move the wheel requiring less arm pull/push to move the wheel, reducing the strain on the user's shoulders. Brake levers can be provided on the handle-bars for the user to control braking and steering. Steering can be accomplished, for example when only one brake is used at a time. When both braking levers are pulled that will trigger the brake on all three wheels and the device will reduce the speed or come to a stop (depending on the intensity of the brake applied by the user). The handle-bars can be adjustable in height and in shape, from linear to curve as needed for the design of the whole device and as desired by the user. The device is configurable to allow different levels of assisted propulsion from the rear-centered wheel in conjunction with any of the manual modes and the powered modes.

Additionally, the device can be controlled by manually operated electrical controls or through a human-machine interface console. Electric controls can be provided for the automatic or self-propelled functions of the vehicle allowing, but not limited to, the following modes: Indoor mode: The device will steer and propel powering only the (front) Mecanum wheels. Those wheels will be controlled by a Mecanum drive algorithm; Outdoor mode: the device will use a synchronized all-wheel drive. The central rear wheel is the primary driving wheel and the two Mecanum wheels are slaved to it using a Mecanum drive algorithm to steer.

The device can be completely controlled via a frontal console, attached on top of the frontal arch, that uses a software specially designed for the device. The console can have a plurality of functions including on the one hand the control of all the device functions, and on the other hand allowing the user to have a access to the internet, social media and other people (family, doctors, caretakers, technical support), enabling for GPS positioning for the user, and diagnostic systems: that can record all data associated with the user and usage and input the data into a database.

A metallic or alloy hydraulic manifold capable of receiving input from the driver in the form of hand operated brake levers capable of controlling the directionality as well as braking by distributing hydraulic fluid power can also be provided.

Configurations of the device allow for a hands-free steering and directional control by placing the padded steering control under the arms of the user, around the side of the torso of the user. It will have different grip/padded options to adjust to the chest/torso size of the user. The direction of the device can then be controlled by the tilt or rotation of the body. To control the steering, the steering bar is connectable by cables or hydraulic lines to the frontal Mecanum wheels, and use a differential braking system that when the bar is turned in one direction will reduce or stop the movement of one of the Mecanum wheels, and allow the device to turn in that direction (and similarly to the other direction). Alternatively the handle bars will be able to rotate upon the user control and the cables connecting to the front wheels will pull them to turn to one side or to the other by the direction without breaking or stopping the motion of the wheels, instead, just controlling the direction of the frontal wheels and therefore of the device. The bars connecting the steering control to the base of the device can be adjusted in height and since its connected to the base of the seat that goes up and down it goes up and down as the seat does.

Height adjustability can be achieved using an elevating seat system that allows a range of positions between a lower (seating) position to an elevated (standing) position, and all positions in between. The height and adjustability of the seat can be accomplished by two electric linear actuators, frontal and rear, connected to the seat base plate and two pivot points on the sub-frame. This allows the seat to rise from a lower level (sitting position) to an elevated level (standing position) giving the user a range of height positioning. The seat tilt is, in turn, controlled by the seat tilt linear electric actuator, which is connected to the seat and to the frontal actuator. The frontal and back actuators are connected in the base to the sub-frame through actuator mounting brackets. The powered seat is controlled by the onboard microcontroller and capable of monitoring the absolute position of the electric linear motors. Importantly, one of the unique properties of the device is that the powered seat travels from front to back (in addition to up and down), which can assist in transferring the user onto the device from either a sitting or a standing position. The user then mounts and unmounts on the device from the rear of the unit using this innovative system. Alternative mechanisms can be used to accomplish this elevating function. The system can combine the linear actuators that instead of connecting directly to the seat plate connect to a lower plate from which a vertical actuator stems that allows the seat to move up and down. In addition, a different elevating system can be used, in which the seat can alternate between sitting and standing position using a central vertical actuator. In this system, the seat does not travel from the back to the front of the device, but rather stays in a centered position.

The two frontal wheel assemblies can be configured as Mecanum wheels wherein each wheel consist of a hub with a timing pulley and a disc brake rotor connected to an axel with a hydraulic caliper and brake pad assembly. The axel is fixed to the sub-frame with or without suspension. The material of the Mecanum wheels will be an aluminum hub construction with a urethane or similar peripheral wheels. The central rear wheel is a tubed pneumatic tire with an in-hub Brushless electric DC motor (“BLDC motor”). This assembly allows for a more compact and less complex modular structure. The tire of this wheel is a pneumatic wheel, 12-26 inches in diameter, with possibility to use all terrain or street tread.

The sub-frame can be made either using metal or alloy tubing, sheet metal, fiberglass, carbon fiber or aramid fiber construction. The sub-frame consist of structural elements to house the electronics, hold the motors, wheels, battery, seat support, and any other supporting structural elements, lights, and any fundamental features of the device.

Covering the sub-frame will be the body of the device that will give the appearance, shape and external design of the device. This body can also be made using metal or alloy tubing, sheet metal, fiberglass, carbon fiber or aramid fiber construction. This body is configurable to have an external shell that is changeable, subjected to different designs and can change the exterior look of the device to suit the user.

The seat is a specially designed seat for easy mount from the back. The seat is designed as a tryptic platform, the two lateral sections of the platform act as wings, folding down when the user is off the chair, allowing the user to mount from the back (with the two side wings down), then as the user gets on the seat, the two wings will lift up to become an spacious, roomy, seating platform for the user. The seat could have instead a saddle-type design, a bicycle type design or a, square or rectangular design. The seat is connected to a frontal arch that also acts as frontal support, especially when the user is tilted forward, it also can serve as a handle to help grabbing the device while mounting, and is connected to safety stabilizing straps that help mounting as well as keep the user secured to the chair. In addition, the seat has a backrest that helps mounting (sliding to and from the device to bed, toilet, chair, and any other surface), stabilizing the body and providing comfort (see below). Importantly, the dimensions of the seat are customizable.

Commercially available air, gel, or foam cushions can be used for the wheelchair seats, such as but not limited to: Roho Enhancer Cushion available from RSW Stores, an authorized retailer for The ROHO Group. See, www.pressuresorecushions.com.

A frontal arch is attached to the base of the seat and contains two side-bars and a connecting upper bar, giving the shape of an arch. This frontal piece allows the body to have a frontal support when the user is tilted forward. In addition, this frontal arch allows three different features: the center hole or aperture can be used by male users to access and use of urinal without having to use an accessible bathroom: the side bars are used as handles (when mounting, or when using the device); and the side apertures can be connected to safety straps.

A back support can be a pivoting back-rest that pivots around the axis on its base that connects with the seat platform. The back-rest then can be in upright position, in horizontal position or in downright position (tucking below the seat). This pivotal position allows the back rest, when is in horizontal position, to serve as a platform to help the user mount from bed (toilet or other surface) to device and vice versa. The back rest contains horizontal rolling cylinders that help the patient to roll on the backrest into the seat. The seat has two lateral slots that connected to safety back straps to provide an assisted and safe incorporation onto the chair. The backrest in addition houses foldable and retractable armrests. Moreover, the backrest contains anchoring systems to attach accessories, such as a backpack. The backrest will come in different sizes depending on the users type of disability and needs. The backrest will pivot on its axes either by the pull of straps, but the use of latches or controlled by a motor, and can be locked in the different positions by the user. Back rest can be made of carbon fiber, glass fiber, titanium, rubber among other materials.

An armrest can be provided which is connectable to the back seat in either of two modalities. A) Attached through a bar to the back of the backrest or B) each individual arm rest is integral to the backrest on each side. In both versions, the armrest can fold to be in level (in parallel) with the backrest (folded position) or in a 90 degree position with respect to the backrest (active position). The arm rest is in turn comprised of two cylinders, one, the main (base) cylinder is of an smaller radius and connects to the backrest, the other, the (extending) cylinder has a higher radius and can slide back and forth over the base cylinder, allowing for the arm rest to extend or retract, Connected to the base cylinder is a cushion/padded armrest support.

Safety back straps can be provided. For example, straps are connectable to the frontal arch, they extend to be placed over the head of the user and down behind the back. From the central back strap band, two side bands hang that go behind the user and below the thighs and attach through a notch/slot to the backrest. The back strap may have a coiling system (on the frontal arch side) that pull them forward bringing the user closer onto the chair. Additionally, or in the alternative, individual straps attach on either side of the user (from the frontal arch to the backrest). Safety back straps will come in different sizes and support level depending on the disability of the user and their needs.

A knee brace support system is attached to the sub-frame at the level of the knee, it can have an upper strap element that connects to the thigh of the user and a lower strap element that connects to the tibia of the user. The upper part has an anterior and posterior back straps. The lower part has one anterior tibia strap and a back posterior tibia strap. The upper and lower anchors are connected through a padded knee support connected to the sub-frame.

A foot rest can be provided which is connected to the base of the sub-frame. The footrest can have a back and front support that keeps the foot in a semi-locked or secured position,

Suspension is configurable to provide smooth ride in any condition and terrain minimizing the bouncing while riding.

Compactness of the overall footprint of the device is achieved by providing a main driving wheel in a central position under the body and in between the legs. Additionally, the seat is tryptic so the wings can be folded down. The design enables the device to have a smaller dimension and makes it suitable to access regular doors and otherwise non accessible or difficult to access places.

Additionally, accessories can be provided which are connectable to the sub-frame and or the base of the linear actuators, with an easy to click system. Accessories include: backpack and connectors for engaging a backpack, umbrella and a mount for holding the umbrella, tray, cup holder, oxygen holder, urine collector, USB charging port, rain cape, leg warmers, feet cover, and feet warmer.

Additionally the device can include rear view mirrors, lights (frontal and rear), blinkers, honk, emergency signals, and many other accessories.

### INCORPORATION BY REFERENCE

All publications, patents, and patent applications mentioned in this specification are herein incorporated by reference to the same extent as if each individual publication, patent, or patent application was specifically and individually indicated to be incorporated by reference. A variety of solutions are disclosed in, for example, US 2014/0326521 A1, published Nov. 6, 2014, for Transport Device; U.S. Pat. No. 8,844,961 B1 issued Sep. 30, 2014, for Stand-up Unit for Stand-up Wheelchairs and Chairs, Particularly Therapy Chairs; US 2013/0287032 A1 published Oct. 24, 2013, for Stand-up Unit for Stand-up Wheelchairs and Chairs, Particularly Therapy Chairs; WO 2013/047756 A1 published Apr. 4, 2013 for Wheelchair Motorization Device; U.S. Pat. No. 8,403,352 B2 issued Mar. 26, 2013, for Stand-up Unit for Stand-Up Wheelchairs and Chairs, Particularly Therapy Chairs; US 2011/0215540 A1 published Sep. 8, 2011, for Vehicle with Central Wheel Drive, in Particular a Wheelchair or Stand-up Wheelchair; US 2010/0207354 A1 published Aug. 19, 2010 for Stand-up Unit for Stand-up Wheelchairs and Chairs, Particularly Therapy Chairs; WO 2009/026731 A1 published Mar. 5, 2009; WO 2009/009913 A1 published Jan. 22, 2009; US 2008/0169136 A1 published Jul. 17, 2008, for Wheelchair with a Middle Wheel Drive, in Particular Raising Wheelchair; U.S. Pat. No. 7,219,912 B2 issued May 22, 2007 for Raising Wheelchair; U.S. Pat. No. 7,007,963 82 issued Mar. 7, 2006, for Raising Wheelchair; WO2005/097033 A1 published Oct. 20, 2005; US 2004/0174058 A1 published Sep. 9, 2004, for Raising Wheelchair; US 2004/0173998 A1 published Sep. 9, 2004 for Raising Wheelchair; U.S. Pat. No. 6,125,957 A issued Oct. 3, 2000, for Prosthetic Apparatus for Supporting a User in Sitting or Standing Positions; U.S. Pat. No. 5,785,384 A issued Jul. 28, 1998 for Arrangement in an Adjustable Chair; U.S. Pat. No. 5,366,036 issued Nov. 22, 1994, for Power Stand-up and Reclining Wheelchair; U.S. Pat. No. 5,265,689 A issued Nov. 30, 1993 for Prosthetic Device for Lifting and Lowering a Person Thereon; and U.S. Pat. No. 4,506,930A issued Mar. 26, 1985 for Wheelchair Adapted to Enable the Patient to Stand-up.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-1B are perspective views of a mobility device according to the disclosure; FIGS. 1D-1F are front, side, and back views of the mobility device shown in FIG. 1A;

FIGS. 2A-2G are views of a portion of a configurable of a mobility mechanism for the mobility device;

FIG. 3 is a perspective view of an alternate embodiment of a mobility device;

FIGS. 4A-4D are views of a seat mechanism suitable for the mobility devices disclosed herein; and

FIGS. 5A-4C are views the mobility device from various perspectives with a user.

### DETAILED DESCRIPTION

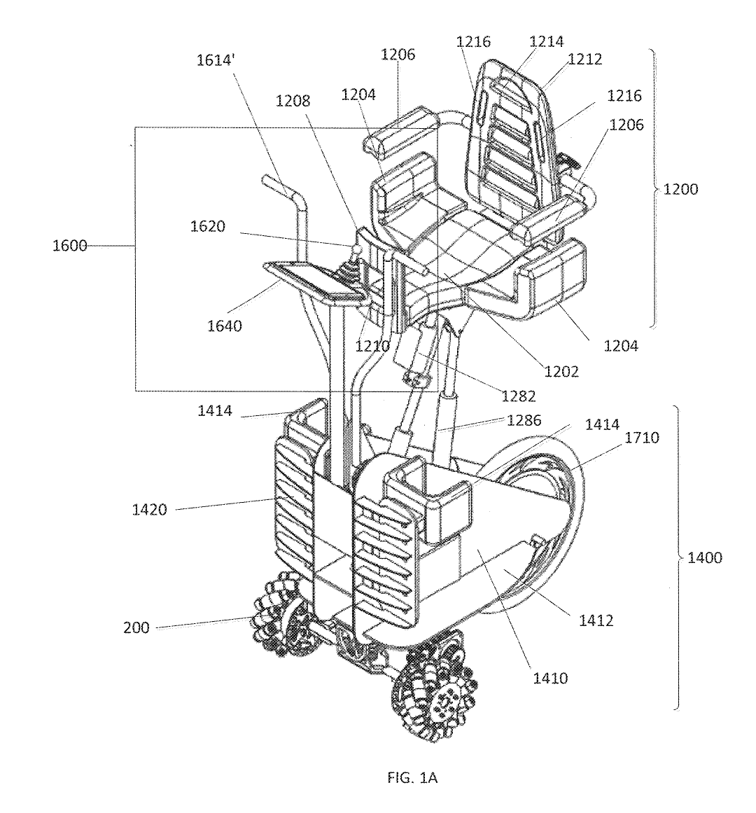

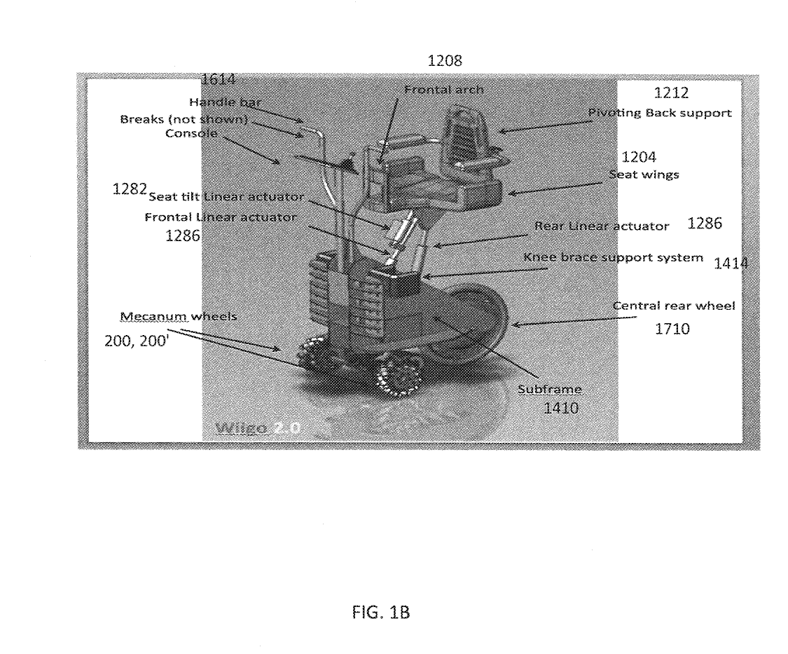

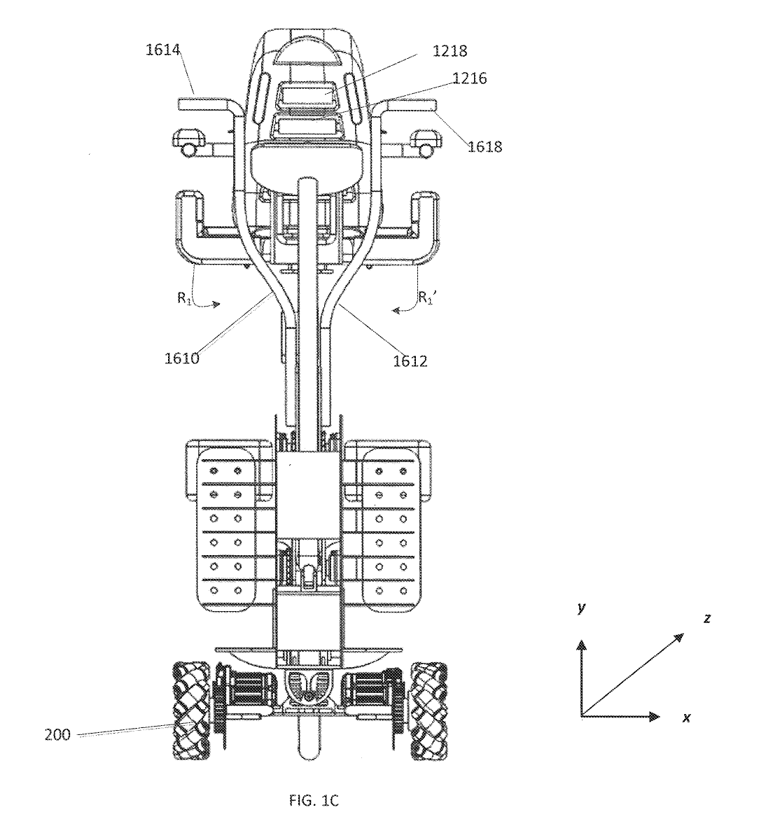

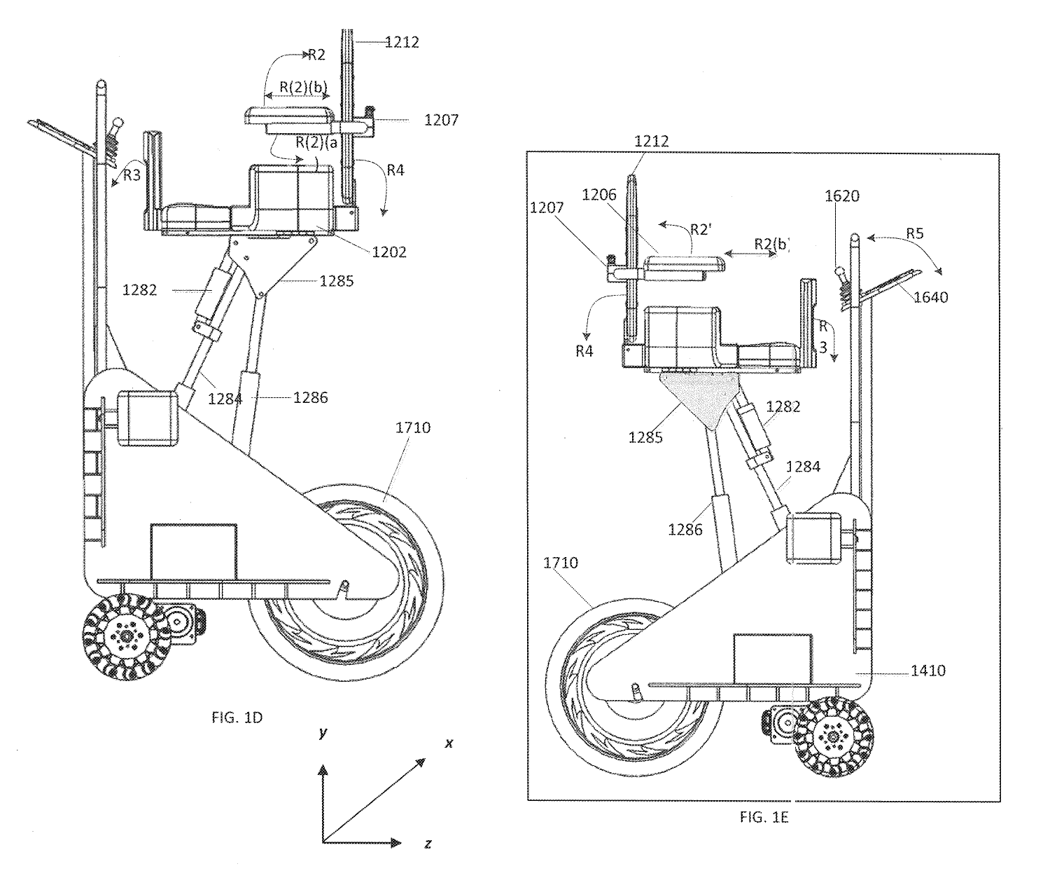

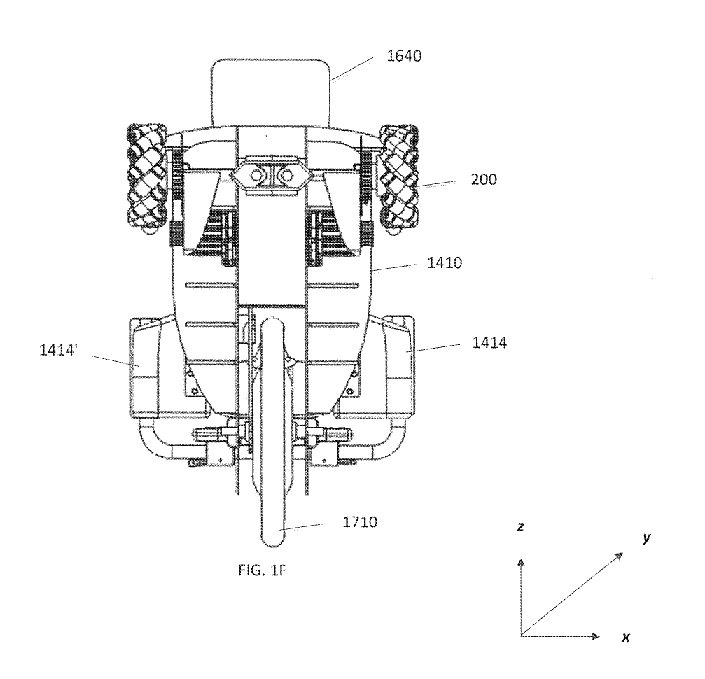

FIGS. 1A-1B are perspective views of a mobility device according to the disclosure. The mobility devices 1000 generally have a base 1400, a seat 1200 and controls 1600.

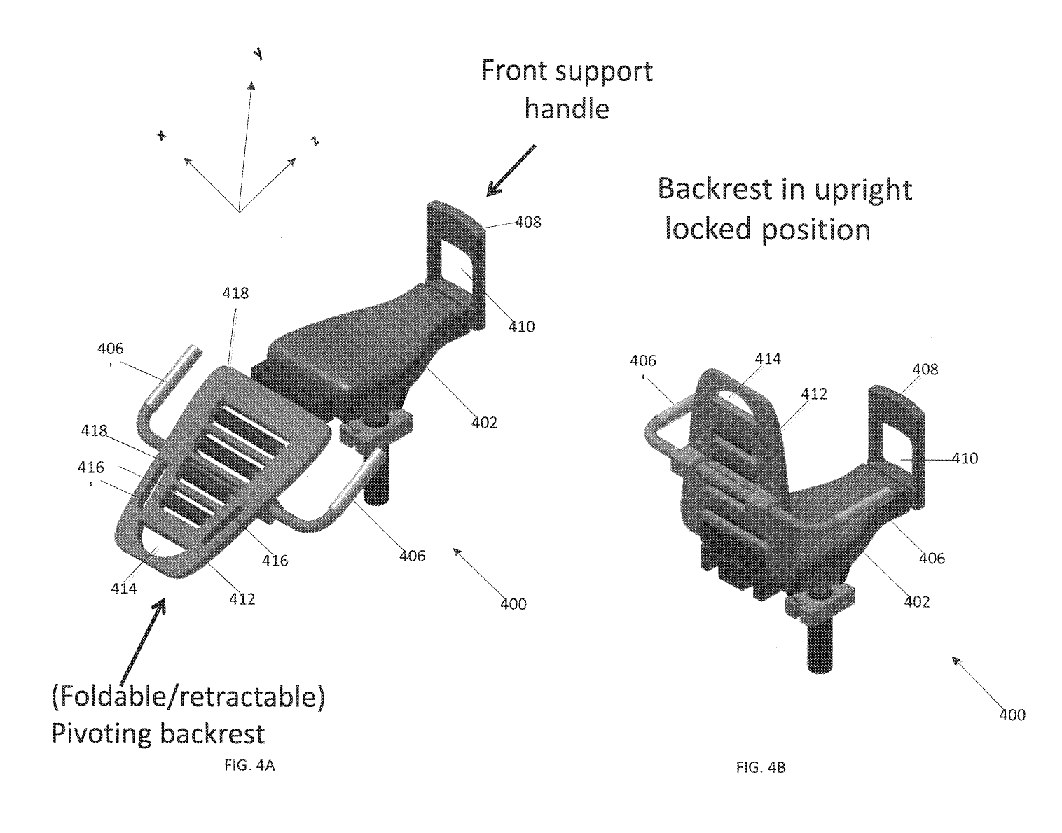

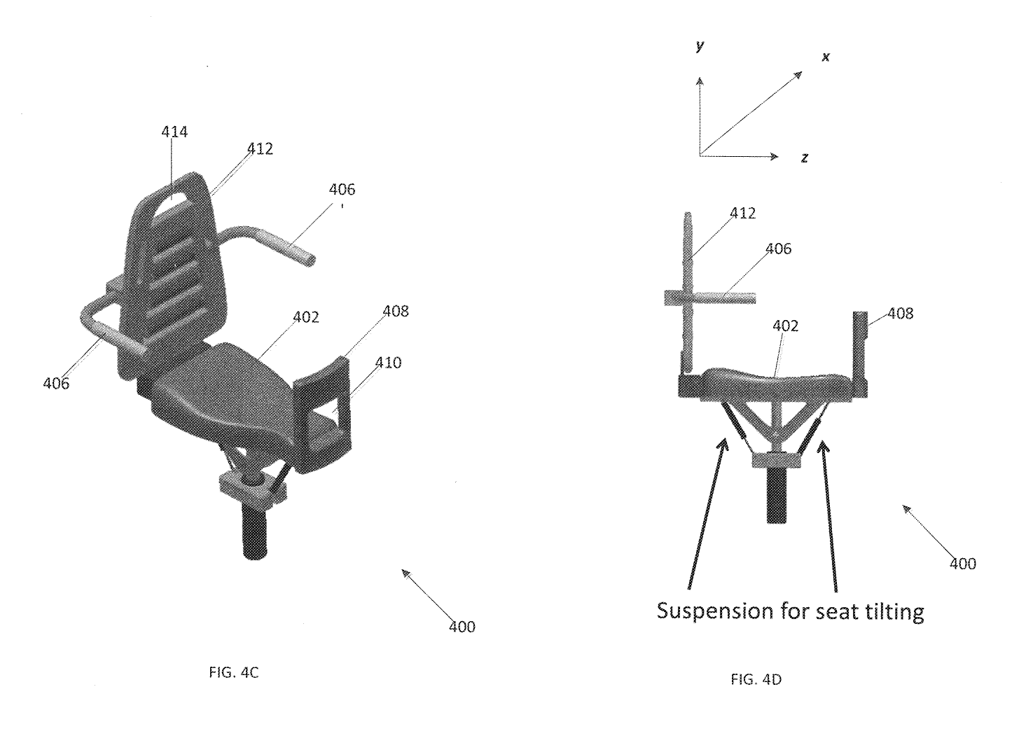

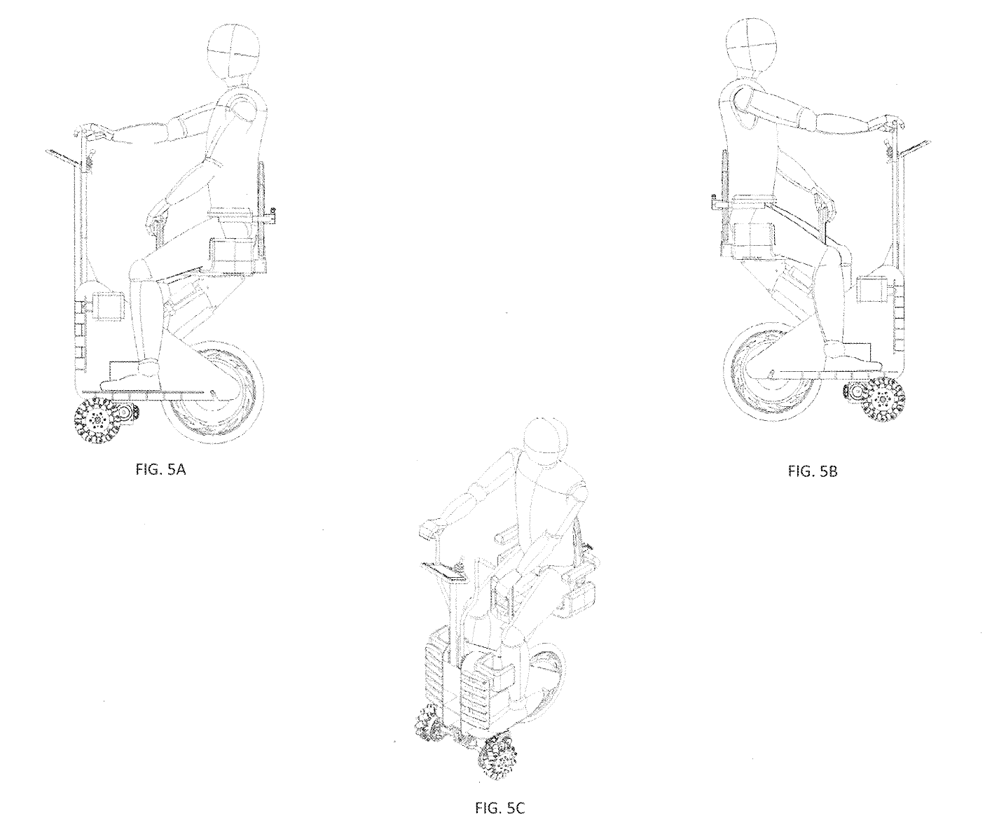

The seat 1200 is discussed in further detail below with respect to FIGS. 4A-4D. The seat 1200 has a main seating body 1202 which is a horizontal portion that can be flat or conformable to a user's buttocks. As shown in FIGS. 1C-F the seat can, in one configuration be positioned such that it is, for example in an x-y plane. On one or both sides of the main seating body 1202 are seat wings 1204, 1204′ which are connectable to the main seating body such that the seat wings 1204, 1204′ are capable of rotating away R1, R1′ into and away from the x-y plane. One or more side arms 1206, 1206′ can be also provided. The side arms 1206, 1206′ can be connected to an associated side arm. bracket 1207 which engages the back support 1212. The one or more side arms 1206, 1206′ are configurable such that the side arms 1206, 1206′ can be in the same plane as the main seat body 1202 in a first configuration, and rotated upwards R2, R2′ into a position that is perpendicular to the main seat body 1202. Additionally, or in the alternative, the side arms 1206, 1206′ can be rotated downwards R2(a), R2(a)′. Additionally, the length of the side arms 1206, 1206′ can be adjusted by sliding the arms R2(b) backwards and forwards. Any of the side arms 1206, 1206′ and the main seating body 1202 can be provided with padding to provide a soft surface to engage the user.

A frontal arch 1208 is provided which is connectable to a first end of the main seat body 1202. The frontal arch 1208 is connectable to the main seat body 1202 so that the frontal arch can rotate R3 from a first position which is perpendicular, or substantially perpendicular to the main seat body 1202, to a second position which is parallel, or substantially parallel, to the main seat body 1202. The frontal arch 1208 is further configurable to have an arch aperture 1210 formed within the frontal arch 1208 to enable a user to grab the frontal arch 1208 and wrap his or her fingers around. the frontal arch 1208 to grasp the frontal arch 1208.

A back support 1212 is provided which is rotatably connected to the main seat body 1202. The back support 1212 rotates R4 from a position that is perpendicular, or substantially perpendicular, to the main seat body 1202 to a position that is planar, or substantially planar to the main seat body 1212. The back support 1212 has one or more apertures 1214, 1216, 1216′ which enable gripping of the back support. Additionally, one or more rollers 1218, 1218′ can be provided within the back support 1212 to facilitate rolling along the length of the back support 1212 by a user as described below.

A controller 1600 is provided. The controller can have two handle bars 1610, 1612, having handles 1614, 1616 which can be moved R5 in a forward and backward motion to propel the device when operating in a manual mode. Additionally, a handbrake (not shown) can be provided on the handles 1614, 1616 to facilitate stopping the mobility device when in motion. Additionally, the handle bars 1610, 1612 can be push-pulled to achieve movement to the right or left by the user. For example, when the user pulls on the right handle while pushing on the left handle movement to the right is achieved. Conversely, when the user pulls on the left handle while pushing on the right handle, movement to the left is achieved. Moreover, either the handle 1614, or the handle 1616 can be rotated and such rotation translated through the cables into a rotation of the front wheels. Additionally, a joy stick 1620 can be provided to provided additional or alternative mechanism for controlling motion. A computer interface or console 1640 or mounting for a tablet computer can be provided to allow the user to control all the functions of the device as well as provide additional connectivity for the user with interact, phone and social media.

The main seat body 1202 is supported away from the sub-frame 1410 by a set of actuators. The actuators also provide control over the seat position relative to the body 1280 of the device 1000, allowing the device to convert from a seating device to a standing device. A tilt actuator 1282 is connected to a front linear actuator 1284 which is adjacent a rear linear actuator 1286. The front linear actuator 1284, and the rear linear actuator 1286 may further engage an articulating seat bracket 1285 which is affixed to the lower surface of the main seat body 1202.

The base 1400 has a main sub-frame 1410 which has a pair of platforms 1412, 1412′ upon which a user can place his or her feet. A pair of knee supports 1414, 1414′ is provided into which a user's knees can be placed. The knee supports 1414, 1414′ adjust depending on whether the device is in a seated configuration or a standing configuration. Structural supports 1420 are provided to provide integrity to the structure and a solid anchor for the knee support. Additionally, an exterior body (not shown) can be positioned around the base 1400 which closes the device and can also provide a customizable/decorative aspect to the device.

Three wheels 1710, 1720, 1722 are provided. A first wheel 1710 is positioned centrally under the seat 1200. A pair of front/control wheels 1720, 1722 are positioned forward the central wheel. The pair of front/control wheels 1720, 1722 provide steering and control. The pair of front/control wheels 1720, 1722 can be Mecanum wheels. The Mecanum wheels are conventional wheels with a series of rollers attached to its circumference. The rollers typically have an axis of rotation of 45 degrees to the plane of the wheel and at 45 degrees to a line through a center of the roller parallel to an axis of rotation of the wheel. An advantage of the Mecanum wheel is that the device will have increased flexibility in terms of direction of movement. For example, running the wheels on one side in the opposite direction of the wheels on the other side, causes rotation of the device. Running the wheels on one diagonal in a direction that opposes the wheels on the other diagonal will cause sideways movement. As will be appreciated by those skilled in the art, combinations of wheel motions allow for vehicle motion in any direction with any wheel rotation. FIGS. 1D-1F are front, side, and back views of the mobility device shown in FIG. 1A, which facilitate an appreciation for movement of various components of the device.

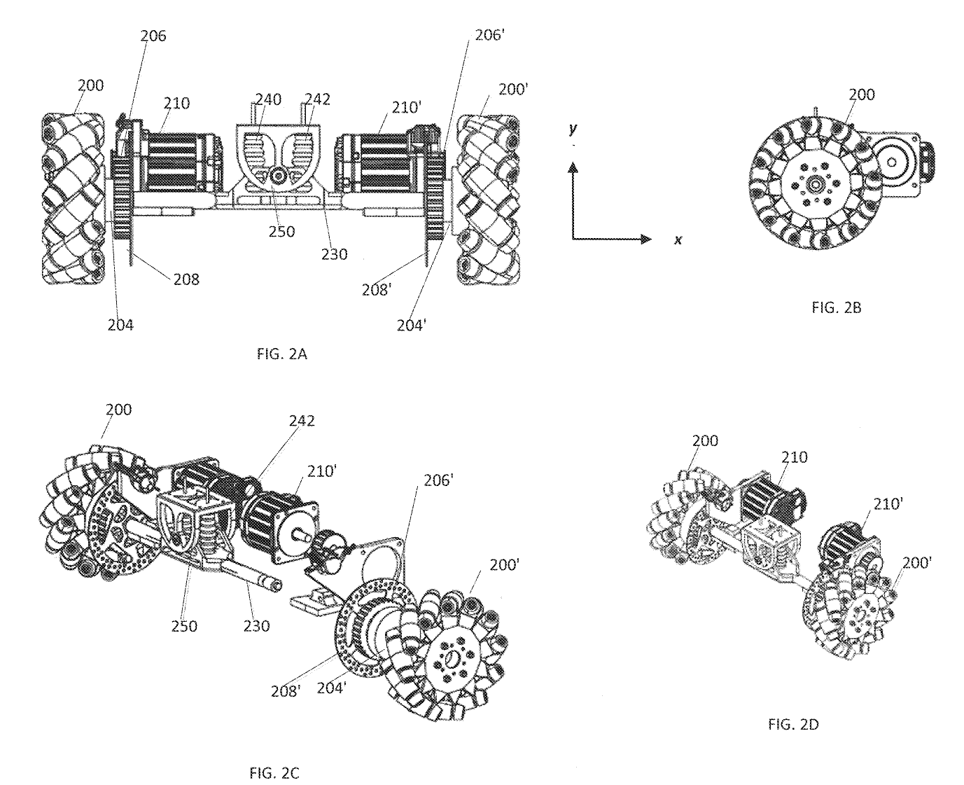

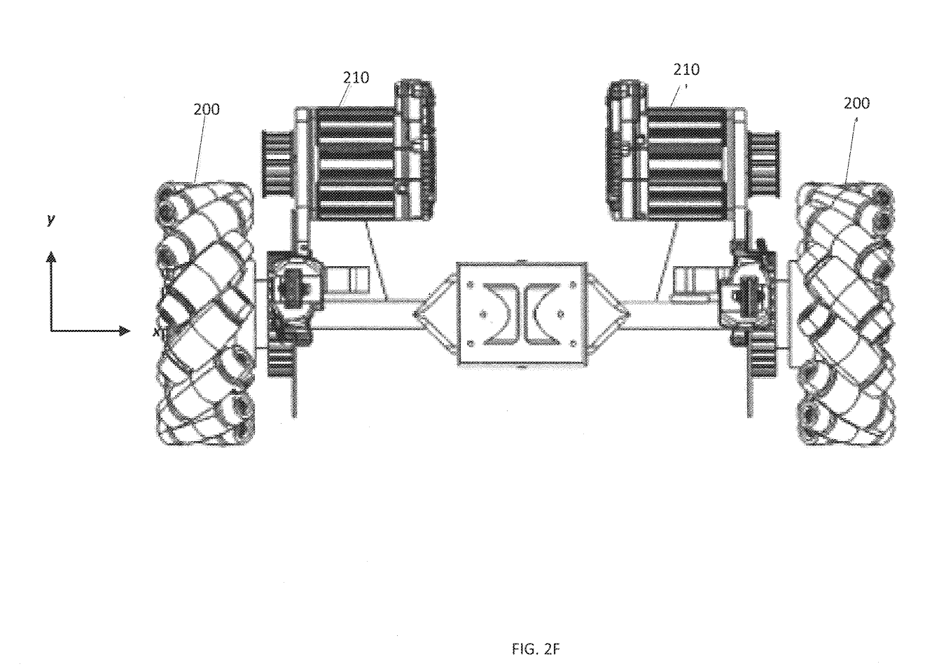

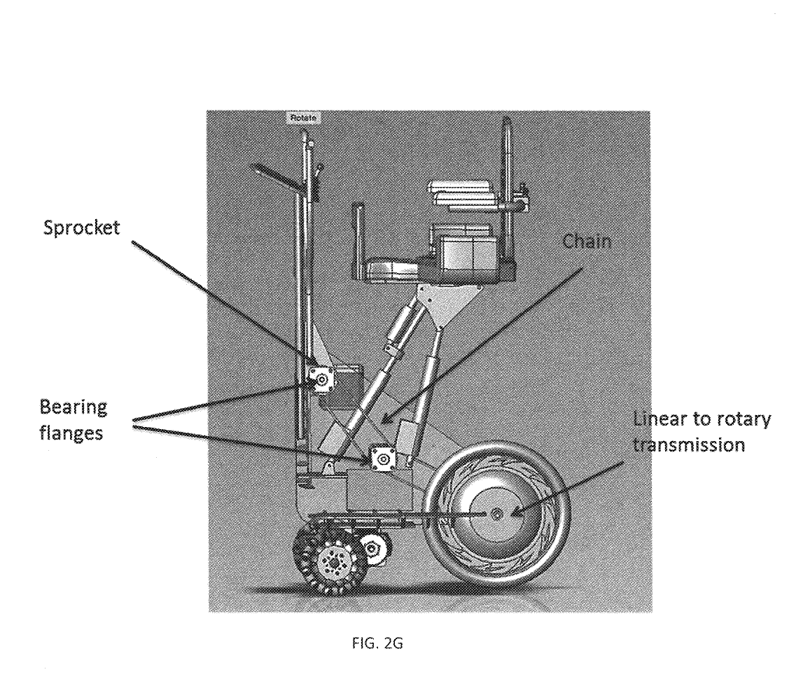

For manual drive operation, the device 1000 is configurable to have, for example, two handle bars 1614, 1614′ that connect via bearing flanges shown in FIG. 2G to a front-centered sub-frame element in which a sprocket holds a chain that connects to the main center wheel 1710, like in a bicycle, and allows for manual movement that propels the device in a manual mode with a push-pull motion of the handle bars. The chain and wheel systems has a linear to rotary transmission system that reduces the effort to move the wheel requiring less arm pull/push to move the wheel, reducing the strain on the user's shoulders.

Turning now to FIGS. 2A-2E are views of a portion of a configurable of a mobility mechanism for the mobility device. In this configuration, each of the front Mecanum wheels 200, 200′ are connected through a hub 206, 206′ (that holds the wheels 200, 200′ to the corresponding bearing 204, 204′ and corresponding disc brake 208, 208′) to a corresponding BLDC motor 210, 210′. A front wheel pivoting axle 230 connects the two Mecanum wheels, Suspension spring elements 240, 242 are provided between the axle 230 and the subframe (1410 in FIG. 1 and FIG. 2A) and housed by a truck 250 to provide mechanical buffering between the user and any rough terrain that the device may be travelling on.

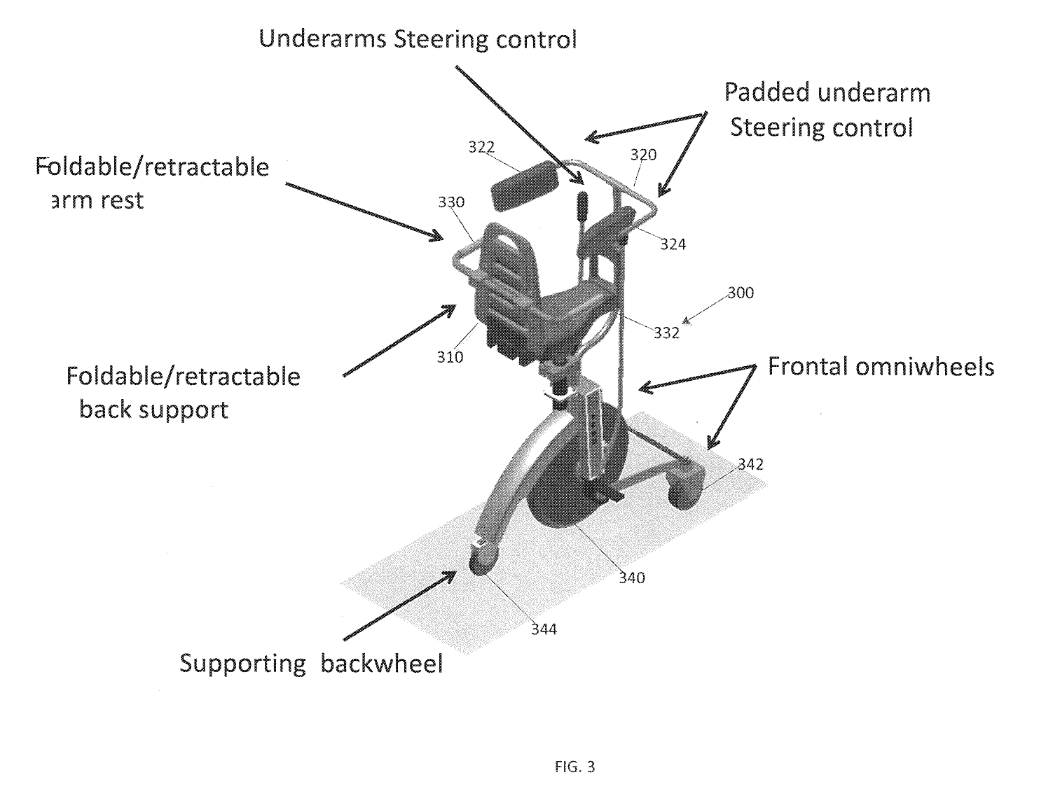

FIG. 3 is a perspective view of an alternate embodiment of a mobility device 300. In this configuration, a steering mechanism 320 is provided which includes side arms 322, 324 which enable a user to control movement of the device 300 by moving his or her torso with the side arms 322, 324 engaged under the user's arms. This steering mechanism can be used as well to hold the users body when he/she wants to be above the seat level without elevating the seat by using the force of the underarms. As with the other configurations, foldable/retractable arm rests 330, 332, are provided, along with a foldable/retractable back support. The wheels include a center wheel 340, a pair of front omni wheels 342, and a rearward supporting back wheel 344.

FIGS. 4A-4D are views of a seat mechanism suitable for the mobility devices disclosed herein. The seat 400 has a main seating body 402, which is a horizontal portion that can be flat or conformable to a user's buttocks. On one or both sides of the main seating body 402 are seat wings 404, 404′ which are connectable to the main seating body such that the seat wings 404, 404′ are capable of rotating away R1, RI' from the plane formed by the main seating body 402. One or more side arms 406, 406′ can be provided. The one or more side arms 406, 406′ are configurable such that the side arms 406, 406′ can be in the same plane as the main seat body 402 in a first configuration, and rotated upwards R2, R2′ into a position that is perpendicular to the main seat body 402. Additionally, or in the alternative, the side arms 406, 406′ can be rotated downwards R2(a), R2(a)′ Additionally, the length of the side arms 406, 406′ can be adjusted by sliding the arms R2(b) backwards and forwards. Any of the side arms 406, 406′ and the main seating body 402 can be provided with padding to provide a soft surface to engage the user.

A frontal arch 408 is provided which is connectable to a first end of the main seat body 402. The frontal arch 408 is connectable to the main seat body 402 so that the frontal arch can rotate R3 from a first position which is perpendicular, or substantially perpendicular to the main seat body 402, to a second position which is parallel, or substantially parallel, to the main seat body 402. The frontal arch 408 is further configurable to have an arch aperture 410 formed within the frontal arch 408 to enable a user to grab the frontal arch 408 and wrap his or her fingers around the frontal arch 408 to grasp the frontal arch 408.

A back support 412 is provided which is rotatably connected to the main seat body 402. The back support 412 rotates R4 from a position that is perpendicular, or substantially perpendicular, to the main seat body 402 to a position that is planar, or substantially planar to the main seat body 412. This function will allow the user accessing the device from and to a bed, a toilet and any other flat surface from where the user needs to access the device. The back support 412 has one or more apertures 414, 416, 416′. In operation, for example aperture 414 enables a user to grip the back support and pull the back support and/or pull the user towards the back support. The user can then roll onto the seat of the device to be fully mounted on the device. Apertures 416, 416′ can accommodate a strap which feeds through the aperture and around the user's torso to secure the user to the device. Additionally, one or more rollers 418, 418′ can be provided within the back support 412 to facilitate rolling along the length of the back support 412 by a user when the user is engaging the device from, for example a prone position.

In one aspect, the back support 1212 pivots so that it is in the same plane as the seat 1202. The seat wings 1204, 1204′ are rotated downward, and the side arms 1206 are rotated up or down. The user then positions him/herself so that his/her legs approach the frontal arch 1208 and pulls himself towards the frontal arch 1208 by grasping the frontal arch 1208 around the aperture through the arch. Once the user's buttocks is on the seat 1202, the back support 1212 can be pivoted upward so that it is perpendicular to the seat 1202, the seat wings 1204, 1204; can be rotated to provide a perpendicular surface to the user's legs when seated. The side arms 1206 are then rotated to be positioned parallel the seat at a location where the user's arms would naturally fall when the arm is bent at the elbow.

In operation, the user can either grab the handle bars 1614 and push/pull the handle bars towards him/herself to provide manual propulsion, or can move the joy stick 1620 to activate the motors to propel the device forwards, backwards, or sideways.

While on the device the user can choose the positioning, lower level (sitting) or upper level (elevated). To alternate between positions the user has different ways to modulate the height (joystick, console, manual). In the sitting position the rear linear actuator will be compressed to his shortest length. When elevating, the rear linear actuator will extend up to the maximum length, the frontal linear actuator will in turn shorten. The tilt linear actuator will allow the user to bend slightly forward (mainly useful when in elevated position) or to recline backwards (mainly useful when in sitting position).

The systems and methods according to aspects of the disclosed subject matter may utilize a variety of computer and computing systems, communications devices, networks and/or digital/logic devices for operation. Each may, in turn, be configurable to utilize a suitable computing device, which can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as a BlackBerry®, iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web-browser, e.g., to provide access to applications and data and other content located on a web-site or a web-page of a web-site. A user may also communicate through the computing device with doctors, caretakers, family, friends, customer support and any other person, using systems such as Skype®, FaceTime®, and the like, using a video or a telephonic communication as well as via text, instant messaging and the like. The computing device may also send technical information to the customer support, related to the performance of the device, such as pressure, temperature, battery life, and any other information from the different components of the device, to provide the customer support information about the status of the device components.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method, which may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like,

The instructions may be stored on a suitable “machine readable medium” within a computing device or in communication with or otherwise accessible to the computing device. As used in the present application a machine readable medium is a tangible storage device and the instructions are stored in a non-transitory way, At the same time, during operation, the instructions may at some times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like, When so stored, the software will constitute a “machine readable medium,” that is both tangible and stores the instructions in a non--transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention, It is intended that the following claims define the scope of the invention and that methods and structures within the scope of these claims and their equivalents be covered thereby.

What is claimed is:

1. A modularized mobility device as described herein.

2. A method of using a modularized mobility device as described herein.

3. Kits for customizing a modularized mobility device as described herein.
